(19) United States
(12) Patent Application Publication
(10) Pub. No.: US 2003/0178132 A1
(43) Pub. Date: Sep. 25, 2003

(54) Method for manufacturing connection structure

(75) Inventor: Junji Shinozaki, Kanuma-shi (JP)

Correspondence Address: OLIFF & BERRIDGE, PLC, P.O. BOX 19928, ALEXANDRIA, VA, 22320, US

(73) Assignee: Sony Chemicals Corp., Tokyo (JP)

(21) Appl. No.: 10/378,975

(22) Filed: Mar. 5, 2003

(30) Foreign Application Priority Data
Mar. 25, 2002 (JP) 2002-083381

(51) Int. Cl. B32B 31/00

(52) U.S. Cl. 156/275.5

(57) ABSTRACT

A connection structure manufacturing method for obtaining a connection structure in which first and second connection terminals are electrically connected, comprises disposing the second connection terminals (connection terminals of a semiconductor element) facing the first connection terminals (connection terminals of a circuit board) through the agency of a thermosetting anisotropic conductive adhesive (anisotropic conductive film), and pressing the second connection terminals while heating and curing the thermosetting anisotropic conductive adhesive. The pressing rate of the second connection terminals is kept at 50 mm/min or less, and the first and second connection terminals are brought into contact through the agency of the conductive particles in the thermosetting anisotropic conductive adhesive before the viscosity of the thermosetting anisotropic conductive adhesive reaches 10⁷ Pa·s as a result of heating and curing.

### BACKGROUND OF THE INVENTION

1. Field of the Invention

The present invention relates to a method for manufacturing a connection structure in which corresponding connection terminals such as connection terminals of a circuit board and those of electronic components mounted thereon are electrically connected by an anisotropic conductive adhesive.

2. Description of the Related Art

Heating and pressing the connection terminals of electronic components and the connection terminals of a circuit board through the agency of an anisotropic conductive adhesive obtained by dispersing conductive particles in a thermosetting insulating adhesive is one of the methods whereby semiconductor elements and other electronic components are connected to circuit boards.

According to this method, a circuit board 2 is mounted on a stage 1, a thermosetting anisotropic conductive adhesive layer is formed by applying a paste-like anisotropic conductive adhesive or superposing an anisotropic conductive adhesive (anisotropic conductive film 4) molded as a film on the connection terminals 3 of the circuit board 2, a semiconductor element 5 is disposed thereon such that the connection terminals 6 of the semiconductor element face the circuit board 2, and the semiconductor element 5 is pressed down with the aid of a bonder or other heating/pressing device 7, as shown in FIG. 1A. Preliminary compression bonding in which the two sets of connection terminals 3 and 6 are electrically connected is thus performed, as shown in FIG. 1B. In the drawings, symbol 8 designates a thermosetting insulating adhesive; symbol 9, conductive particles.

Final compression bonding is subsequently performed by applying heat and pressure with the aid of the same heating/pressing device as above, and after-curing is further carried out using a heating furnace.

In the above method, however, voids 10 are captured during the application of heat and pressure in the preliminary compression bonding (as shown in FIG. 2), and these voids 10 sometimes reduce adhesion between the circuit board 2 and the semiconductor element 5, causing the circuit board 2 or the semiconductor element 5 to peel off and creating connection defects.

It is more difficult to insert the conductive particles 9 between the connection terminals 3 of the circuit board 2 and the connection terminals 6 of the semiconductor element 5 when the connection terminals 6 or connection terminals 3 are provided with a finer pattern, and the two sets of connection terminals 3 and 6 have a narrow lap surface. A resulting drawback is that the semiconductor element 5 and the circuit board 2 are bonded together without the conductive particles 9 being inserted in an adequate manner between the connection terminals 6 of the semiconductor element 5 and the connection terminals 3 of the circuit board 2, and connection defects are created, as shown in FIG. 3.

### SUMMARY OF THE INVENTION

In view of this, an object of the present invention is to reduce the capturing of voids, to hold the conductive particles of an anisotropic conductive adhesive between connection terminals in a secure manner, and to improve connection reliability during the production of a connection structure in which corresponding connection terminals such as connection terminals of a circuit board and those of electronic components mounted thereon are electrically connected by an anisotropic conductive adhesive.

The inventors discovered that the voids can be reduced and the number of conductive particles held between connection terminals can be increased by keeping the pressing rate of the connection terminals during heating and pressing within a predetermined range in a method for manufacturing a connection structure in which corresponding connection terminals are heated and pressed through the agency of a thermosetting anisotropic conductive adhesive.

Specifically, the present invention provides a connection structure manufacturing method for obtaining a connection structure in which first and second connection terminals are electrically connected, comprising disposing the second connection terminals facing the first connection terminals through the agency of a thermosetting anisotropic conductive adhesive, pressing the second connection terminals while heating and curing the thermosetting anisotropic conductive adhesive, wherein the pressing rate of the second connection terminals is kept at 50 mm/min or less; and

the first and second connection terminals are brought into contact through the agency of the conductive particles in the thermosetting anisotropic conductive adhesive before the viscosity of the thermosetting anisotropic conductive adhesive reaches 10⁷ Pa·s as a result of heating and curing.

### BRIEF DESCRIPTION OF THE DRAWINGS

FIGS. 1A and 1B are diagrams illustrating a method for manufacturing a connection structure with the aid of an anisotropic conductive adhesive;

FIG. 2 is a cross-sectional view of a connection structure with voids;

FIG. 3 is a cross-sectional view of a connection structure in which the conductive particles are not adequately held between the corresponding connection terminals; and

FIG. 4 is a diagram depicting the relation between the viscosity and the time when heating an anisotropic conductive film to a prescribed temperature.

### DESCRIPTION OF THE PREFERRED EMBODIMENTS

The present invention is described in detail below with reference to diagrams. In each diagram, identical symbols indicate identical or similar structural elements.

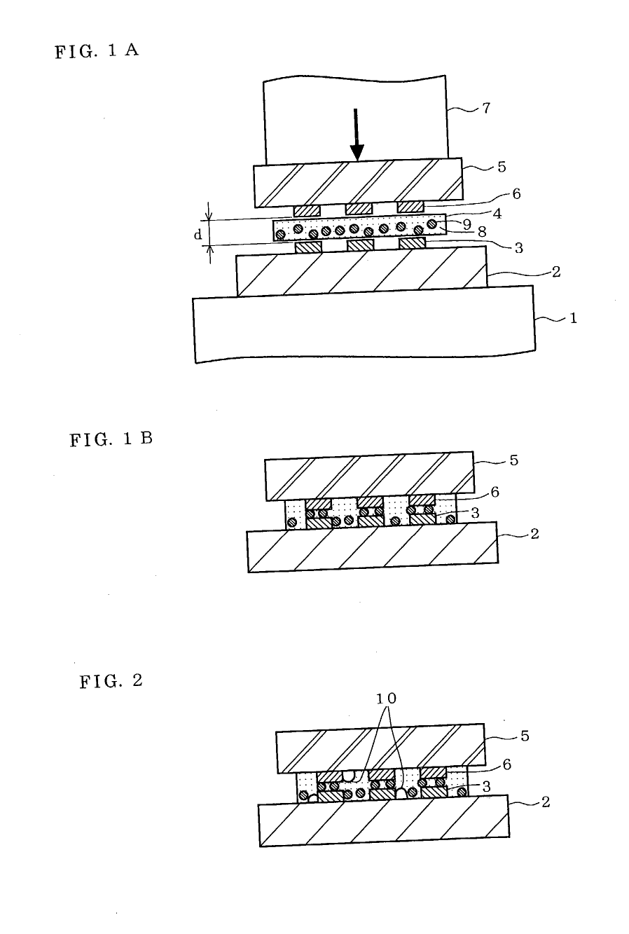

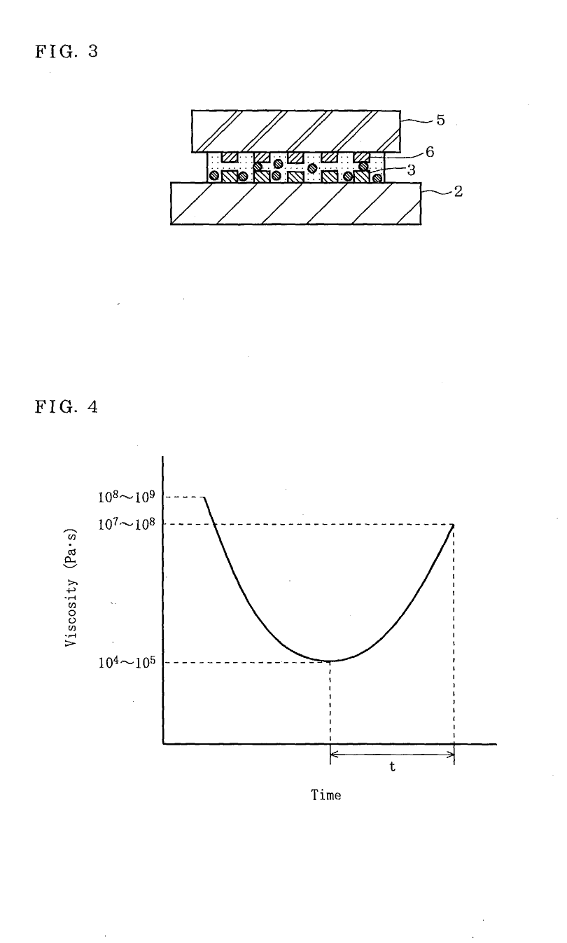

When the inventive method for manufacturing a connection structure is performed such that, for example, the first interconnected terminals are connection terminals formed on a circuit board, and the second connection terminals are connection terminals for an IC or other semiconductor element, a circuit board 2 is first mounted on a stage 1, a thermosetting anisotropic conductive adhesive layer is formed by applying a paste-like anisotropic conductive adhesive or superposing an anisotropic conductive film 4 on the connection terminals 3 of the circuit board 2, a semiconductor element 5 is disposed thereon such that the connection terminals 6 of the semiconductor element face the circuit board 2, and the semiconductor element 5 is pressed down with the aid of a bonder or other heating/pressing device 7 in the same manner as in the conventional method shown in FIG. 1. In this case, the anisotropic conductive film 4 may be heated solely with the heating/pressing device 7 for pressing the semiconductor element 5, and the stage 1 can be provided with a heater and heated as needed.

It was found by the inventors that the anisotropic conductive film 4 commonly has a viscosity of 10⁸ to 10⁹ Pa·s prior to heating as shown in FIG. 4, that continued heating above a prescribed temperature causes the viscosity to decrease to about 10⁴-10⁵ Pa·s (minimum melt viscosity) with increased temperature, and that the viscosity is increased to about 10⁷-10⁸ Pa·s by the subsequent progress of the curing reaction. The viscosity is a numerical value obtained by measuring the rotation-induced shear rate with the aid of an instrument (rheometer) for measuring melt viscosity characteristics.

The result is that if an excessively high pressing rate is maintained when the semiconductor element 5 is pressed down while the anisotropic conductive film 4 is heated and cured using the heating/pressing device 7, pressure is applied between the connection terminals 3 and 6 before there is any increase in the viscosity of the anisotropic conductive film 4, causing the conductive particles 9 to be removed from between the connection terminals 3 and 6 together with the thermosetting insulating adhesive 8, preventing the conductive particles 9 from being held between the connection terminals 3 and 6, and creating connection defects. In view of this, the pressing rate of the semiconductor element 5 is set to 50 mm/min or less, and preferably 20 mm/min or less, to allow the conductive particles 9 to be held between the connection terminals 3 and 6 in a secure manner.

Conversely, an excessively low pressing rate will cause the curing reaction of the anisotropic conductive film 4 to proceed before the connection terminals 3 and 6 come into contact with each other through the agency of the conductive particles 9, and will cause the viscosity to rise to about 10⁷-10⁸ Pas. The connection terminals 3 and 6 will therefore be prevented from coming into contact with each other through the agency of the conductive particles 9, and connection defects will develop. In view of this, a requirement of the present invention is that the connection terminals 3 and 6 be brought into contact with each other through the agency of the conductive particles 9 before the viscosity of the anisotropic conductive film 4 reaches 10⁷ Pa·s as a result of heating and curing.

A specific technique whereby the connection terminals 3 and 6 are brought into contact with each other through the agency of the conductive particles 9 before the viscosity of the anisotropic conductive film 4 reaches 10⁷ Pa·s as a result of heating and curing may, for example, be one in which the pressing rate is kept at or above d/t, where t (min) is the time needed to bring the viscosity of the anisotropic conductive film 4 from the minimum melt viscosity to 10⁷ Pa·s by the curing reaction at a prescribed heating temperature, and d (mm) is the distance maintained between the connection terminals 3 of the circuit board 2 and the connection terminals 6 of the semiconductor element 5 when the circuit board 2 and the semiconductor element 5 are disposed facing each other through the agency of the anisotropic conductive film 4.

Other conditions that should preferably be observed during heating and pressing is that the anisotropic conductive film 4 be heated such that the anisotropic conductive film 4 is cured while passing through the minimum melt viscosity. The curing reaction does not proceed in an adequate manner if the film is not heated such that it passes through the minimum melt viscosity.

Although the heating temperature necessary to heat the anisotropic conductive film 4 such that the film passes through the minimum melt viscosity varies with the type of anisotropic conductive film 4, the heating method, and the like, the heating temperature of the heating/pressing device 7 should commonly be set to 50-120° C., and preferably 60-90° C., when the anisotropic conductive film 4 is heated by the heating/pressing device 7 through the agency of the semiconductor element 5, as shown in FIGS. 1A and 1B.

In the present invention, the anisotropic conductive adhesive is not subject to any particular limitations as long as the adhesive is a thermosetting type, although an adhesive whose minimum melt viscosity is 10⁴ Pa·s or greater, and preferably 10⁵ Pa·s or greater, is preferred because such an adhesive allows conductive particles to be held in an adequate manner between the corresponding connection terminals. The thermosetting insulating adhesive used as a component of the anisotropic conductive adhesive should preferably comprise at least one type of epoxy-based resin component and a curing agent component containing basic nitrogen. The conductive particles constituting the anisotropic conductive adhesive may be solder particles, metal particles such as nickel particles, metal-coated particles obtained by coating the surface of a resin core with a metal, or the like.

Connection terminals connected to each other using a thermosetting anisotropic conductive adhesive in accordance with the present invention are not limited solely to the above-described connection terminals of a circuit board and connection terminals of a semiconductor element. The present invention may be adapted to cases such as those in which pairs of circuit boards are connected together.

### EXAMPLES

Experiments 1-20

An IC chip (outline: 6.3 mm square; bump size: 45 μm square; bump height: 20 μm; bump pitch: 85 μm) was preliminarily pressure-bonded to a flexible printed board (pattern width of connection terminals: 30 μm; pattern pitch: 85 μm; pattern height: 13 μm) by being heated and pressed with the aid of a bonder from the IC chip side through the use of an anisotropic conductive film (ACF), and was then subjected to final compression bonding by being kept for 10 seconds at 190° C., yielding a connection structure.

In the process, the type of anisotropic conductive film, the heating temperature of the bonder used during preliminary compression bonding, and the rate at which the IC chip was pressed with the aid of the bonder were varied as shown in Table 1.

Table 1 also shows the minimum melt viscosity of the anisotropic conductive film used in each Experiment.

The time t needed for the anisotropic conductive film used in each Experiment to change its viscosity from the minimum melt viscosity to 10⁷ Pa·s as a result of a curing reaction at the heating temperature maintained in each of the text examples was measured, as was the distance d maintained between the bumps on the IC chip and the pattern of connection terminals on the flexible printed board when the flexible printed board and the IC chip were placed facing each other through the agency of the anisotropic conductive film, and the value d/t was calculated. The results are shown in Table 1.

Evaluation

(1) Number of conductive particles held: The number of conductive particles held between the bumps on the IC chip and the pattern of connection terminals on the flexible printed board was determined by the microscopic observation of the connection structure obtained in each Experiment, and the average number of particles held per bump in each Experiment was calculated.

(2) Voids: The presence or absence of voids was determined by the microscopic observation of the connection structure obtained in each Experiment, and the results were graded in the following manner.

“A”: Small number

“B”: Moderate number

“C”: Large number

(3) Conduction reliability: The connection structure obtained in each Experiment was subjected to PCT (pressure cooker test: 105° C., 100% RH, 12 hours), conduction resistance was measured before and after the test, the PCT-induced change in conduction resistance was determined, and conduction reliability was graded in the following manner.

“A”: Change in conduction resistance less than 50 mΩ

“B”: Change in conduction resistance 50 mΩ or greater but less than 100 mΩ

“C”: Change in conduction resistance 100 mΩ or greater

The results are shown in Table 1.

TABLE 1

| | ACF | | | | Pressing | Number of | | |
|---|---|---|---|---|---|---|---|---|
| | | Minimum melt | Heating | d/t | rate | particles | | Conduction |
| Experiment | Type | viscosity (Pa · s) | temp. (° C.) | (mm/min) | (mm/min) | held | Voids | reliability |
| 1 | A | 10³(*1) | 40 | 90 | 100 | 3 | C | C |
| 2 | B | 10⁴(*2) | 40 | 70 | 100 | 3.5 | C | C |
| 3 | C | 10⁵(*3) | 40 | 50 | 100 | 3.5 | C | C |
| 4 | B | 10⁴ | 50 | 60 | 100 | 3.5 | C | C |
| 5 | B | 10⁴ | 50 | 50 | 50 | 5 | B | B |
| 6 | C | 10⁵ | 50 | 50 | 50 | 5 | B | B |
| 7 | C | 10⁵ | 60 | 30 | 30 | 6 | B | B |
| 8 | C | 10⁵ | 60 | 8 | 20 | 8 | A | A |
| 9 | C | 10⁵ | 80 | 5 | 20 | 9 | A | A |
| 10 | C | 10⁵ | 90 | 6 | 20 | 9 | A | A |
| 11 | B | 10⁴ | 90 | 20 | 20 | 7 | B | B |
| 12 | C | 10⁵ | 100 | 20 | 20 | 9 | A | B |
| 13 | C | 10⁵ | 120 | 30 | 20 | 9 | A | C |
| 14 | C | 10⁵ | 140 | 35 | 20 | 9 | A | C |
| 15 | C | 10⁵ | 80 | 100 | 100 | 7 | B | B |
| 16 | B | 10⁴ | 140 | 150 | 100 | 6 | C | C |
| 17 | D | 10⁵ | 90 | 6 | 20 | 5 | A | A |
| 18 | E | 10⁵ | 90 | 20 | 20 | 3 | A | B |
| 19 | C | 10⁵ | 90 | 3 | 5 | 8 | A | A |
| 20 | C | 10⁵ | 90 | 7 | 3 | 0 | A | C |

NOTES on Table 1
ACF resin
Anisotropic conductive film A: content of conductive particles 10 vol %; insulating adhesive: 16 weight parts phenoxy resin, 76 weight parts epoxy resin, 8 weight parts imidazole
Anisotropic conductive film B: content of conductive particles 10 vol %; insulating adhesive: 27 weight parts phenoxy resin, 65 weight parts epoxy resin, 8 weight parts imidazole
Anisotropic conductive film C: content of conductive particles 10 vol %; insulating adhesive: 35 weight parts phenoxy resin, 57 weight parts epoxy resin, 8 weight parts imidazole
Anisotropic conductive film D: content of conductive particles 6 vol %; insulating adhesive: 35 weight parts phenoxy resin, 57 weight parts epoxy resin, 8 weight parts imidazole
Anisotropic conductive film E: content of conductive particles 4 vol %; insulating adhesive: 35 weight parts phenoxy resin, 57 weight parts epoxy resin, 8 weight parts imidazole
(*1) Due to inadequate heating of the anisotropic conductive film, the anisotropic conductive film does not reach 10³ Pa · s (inherent minimum melt viscosity) during heating and pressing.
(*2) Due to inadequate heating of the anisotropic conductive film, the anisotropic conductive film does not reach 10⁴ Pa · s (inherent minimum melt viscosity) during heating and pressing.
(*3) Due to inadequate heating of the anisotropic conductive film, the anisotropic conductive film does not reach 10⁵ Pa · s (inherent minimum melt viscosity) during heating and pressing

The results of Table 1 indicate that only a small number of conductive particles is held and the conduction reliability is low when the pressing rate is as high as 100 mm/min (Experiment Nos. 1-4).

It can also be seen that when the pressing rate is as low as 3 mm/min (Experiment No. 20), the anisotropic conductive film cures before the bumps on the IC chip and the pattern of connection terminals on the flexible printed board come into contact with each other through the agency of conductive particles, resulting in low conduction reliability.

It can further be seen that when the pressing rate is set to 20 mm/min, good conduction reliability can be ensured at a heating temperature of 50-100° C. and that the reaction velocity increases when the heating temperature is set to 120° C., with the result that the pressing rate falls below d/t, the anisotropic conductive film is cured before the bumps on the IC chip and the pattern of connection terminals on the flexible printed board come into contact with each other through the agency of conductive particles, and the conduction reliability decreases (Experiment Nos. 12, 14, 16).

According to the present invention, fewer voids are captured and the number of conductive particles of an anisotropic conductive adhesive held between the connection terminals can be increased during the production of a connection structure in which the corresponding connection terminals are electrically connected by the anisotropic conductive adhesive, making it possible to improve the adhesiveness and conduction reliability of the connection structure.

In addition, the cost of producing the connection structure can be reduced because increasing the number of conductive particles in the anisotropic conductive adhesive held between the connection terminals can ensure improved conduction reliability even when the concentration of conductive particles in the anisotropic conductive adhesive is reduced.

The entire disclosure of the specification, claims, summary and drawings of Japanese Patent Application No. 2002-083381 filed on Mar. 25, 2002 is hereby incorporated by reference.

What is claimed is:

1. A connection structure manufacturing method for obtaining a connection structure in which first and second connection terminals are electrically connected, comprising disposing the second connection terminals facing the first connection terminals through the agency of a thermosetting anisotropic conductive adhesive, pressing the second connection terminals while heating and curing the thermosetting anisotropic conductive adhesive,
wherein the pressing rate of the second connection terminals is kept at 50 mm/min or less; and
the first and second connection terminals are brought into contact through the agency of conductive particles in the thermosetting anisotropic conductive adhesive before the viscosity of the thermosetting anisotropic conductive adhesive reaches 10⁷ Pa·s as a result of heating and curing.

2. The method for manufacturing a connection structure according to claim 1, wherein the pressing rate is kept at 20 mm/min or less.

3. The method for manufacturing a connection structure according to claim 1 or 2, wherein the heating temperature of the thermosetting anisotropic conductive adhesive is set to 50-120° C.
